(19) United States
(12) Patent Application Publication
(10) Pub. No.: US 2022/0216660 A1
(43) Pub. Date: Jul. 7, 2022

(54) CONNECTOR, METHOD FOR CONNECTING CONTACT PIN, CONTACT PIN, AND STORAGE MEDIUM

(71) Applicant: KABUSHIKI KAISHA TOSHIBA, Tokyo (JP)

(72) Inventors: Akira TANAKA, Yokohama (JP); Masaya HIRASHIMA, Yokohama (JP)

(73) Assignee: KABUSHIKI KAISHA TOSHIBA, Tokyo (JP)

(21) Appl. No.: 17/470,442

(22) Filed: Sep. 9, 2021

(30) Foreign Application Priority Data
Jan. 4, 2021 (JP) 2021-000166

(51) Int. Cl. H01R 24/62; H01R 13/24; H01R 13/03

(52) U.S. Cl. CPC H01R 24/62; H01R 2107/00; H01R 13/03; H01R 13/24

(57) ABSTRACT

A connector includes a casing and a contact pin. The casing includes a storage portion. A connection body is mounted in the storage portion by being relatively displaced in a first direction. The contact pin is held by the casing. The contact pin includes an elastic contact part. The elastic contact part includes a first protrusion and a second protrusion. The first protrusion protrudes toward the storage portion. The second protrusion is separated from the first protrusion. The second protrusion faces a direction crossing the storage portion. The second protrusion protrudes in a direction crossing the first direction.

### CROSS-REFERENCE TO RELATED APPLICATIONS

This application is based upon and claims the benefit of priority from Japanese Patent Application No. 2021-000166, filed on Jan. 4, 2021; the entire contents of which are incorporated herein by reference.

### FIELD

Embodiments relate to a connector, a method for connecting a contact pin, a contact pin and a storage medium.

### BACKGROUND

In a connector that is electrically connected with a connection body such as a card-type storage medium or the like, the contact stability of the contact points of contact pins is important, and countermeasures for conduction defects are difficult due to micro foreign matter that is difficult to see with the naked eye.

### BRIEF DESCRIPTION OF THE DRAWINGS

FIG. 1 is a perspective view showing an open state of a connector according to a first embodiment, and shows an example of a state in which the storage medium is inserted;

FIG. 2 is a perspective view showing a closed state of the connector according to the first embodiment, and shows a state in which the storage medium is mounted;

FIG. 3A is a perspective view showing a contact pin of the first embodiment; FIG. 3B is a plan view of the contact pin; and FIG. 3C is an enlarged cross-sectional view along line B-B′ shown in FIG. 3B;

FIGS. 4 to 6 are partial cross-sectional views along line A-A′ shown in FIG. 2, and show a process of mounting the storage medium;

FIG. 7A is a perspective view showing a contact pin according to a second embodiment; and FIG. 7B is a plan view of the contact pin;

FIG. 8A is an enlarged perspective view showing a tip of a contact pin according to a third embodiment; and FIG. 8B is a plan view of the tip of the contact pin;

FIG. 9A is an enlarged perspective view showing a tip of a contact pin according to a fourth embodiment; and FIG. 9B is a plan view of the tip of the contact pin;

FIG. 10 is an enlarged perspective view showing a tip of a contact pin according to a fifth embodiment;

FIG. 11 is an enlarged perspective view showing a tip of a contact pin according to a sixth embodiment;

FIG. 12 is an enlarged perspective view showing a tip of a contact pin according to a seventh embodiment; and

FIG. 13 is an enlarged perspective view showing a tip of a contact pin according to an eighth embodiment.

### DETAILED DESCRIPTION

A connector according to one embodiment includes a casing and a contact pin. The casing includes a storage portion. A connection body is mounted in the storage portion by being relatively displaced in a first direction. The contact pin is held by the casing. The contact pin includes an elastic contact part. The elastic contact part includes a first protrusion and a second protrusion. The first protrusion protrudes toward the storage portion. The second protrusion is separated from the first protrusion. The second protrusion faces a direction crossing the storage portion. The second protrusion protrudes in a direction crossing the first direction.

A method for connecting a contact pin according to one embodiment is a method connecting the contact pin of a connector to an electrode of a connection body by mounting the connection body in the connector by relatively displacing the connection body in a first direction. The method includes causing a second protrusion of the contact pin to have sliding contact with a surface of the electrode, and causing a first protrusion of the contact pin to contact a region of the surface of the electrode after the second protrusion has slid over the region. The first protrusion is located at the first-direction side of the second protrusion.

A contact pin according to one embodiment includes an elastic contact part, a holding part, and a connection part. The elastic contact part includes a first protrusion and a second protrusion. The first protrusion protrudes upward. The second protrusion is separated from the first protrusion in a longitudinal direction. The second protrusion protrudes upward. The holding part is linked to the elastic contact part. The holding part is held by a housing. The housing includes an insulating resin. The connection part is linked to the holding part. The connection part is exposed from under the housing.

A storage medium according to one embodiment is connectable to a connector. The connector includes a casing and a contact pin. The casing includes a storage portion. The contact pin includes an elastic contact part. The storage medium is mounted to the storage portion by being relatively displaced in a first direction. The storage medium includes an electrode surface electrically connected with a first protrusion of the elastic contact part. The first protrusion protrudes toward the storage portion. A second protrusion of the elastic contact part slides on the electrode surface. The second protrusion is separated from the first protrusion and protrudes toward a direction crossing the first direction.

Exemplary embodiments will now be described with reference to the drawings.

The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions. In the specification of the application and the drawings, components similar to those described in regard to a drawing thereinabove are marked with like reference numerals; and a detailed description is omitted as appropriate.

### First Embodiment

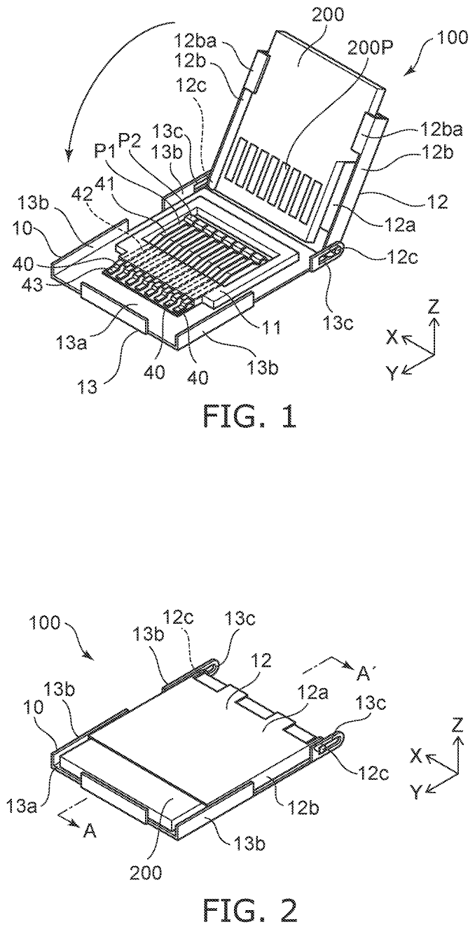

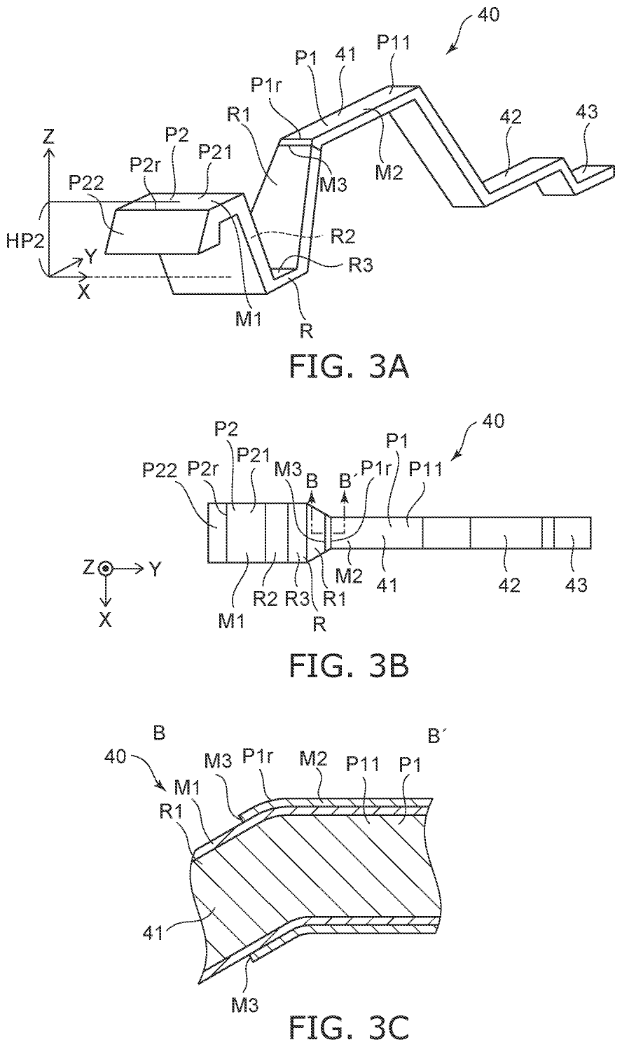

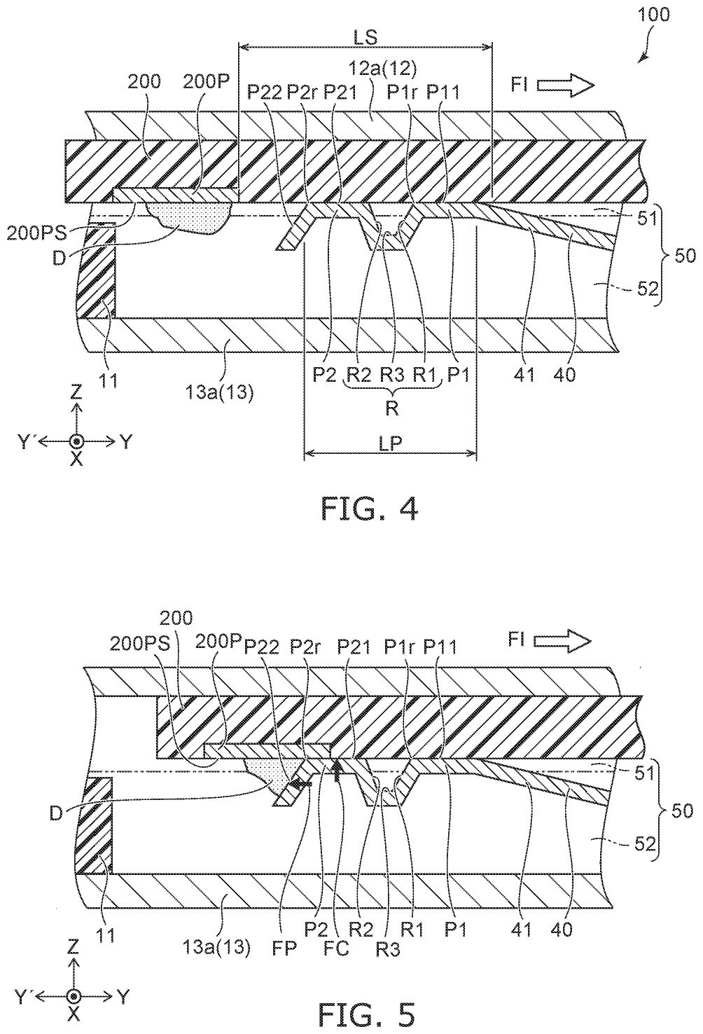

FIG. 1 is a perspective view showing an open state of a connector according to the embodiment, and shows an example of a state in which the storage medium is inserted. FIG. 2 is a perspective view showing a closed state of the connector according to the embodiment, and shows a state in which the storage medium is mounted. FIG. 3A is a perspective view showing a contact pin of the embodiment; FIG. 3B is a plan view of the contact pin; and FIG. 3C is an enlarged cross-sectional view along line B-B′ shown in FIG. 3B. FIGS. 4 to 6 are partial cross-sectional views along line A-A′ shown in FIG. 2, and show a process of mounting the storage medium. FIG. 3C is an enlarged cross-sectional view showing the vicinity of a plating boundary line. The plating is not illustrated in FIGS. 4 to 6.

As shown in FIGS. 1 and 2, the connector 100 houses, for example, a card-type storage medium (referred to as a connection body in the claims and as a “card 200” hereinafter) and is electrically connected with the card 200. The card 200 is, for example, a micro SD. Substantially the entire card 200 is formed of a synthetic resin material; for example, eight electrodes 200P (referred to as metal terminals in the claims) are arranged in a partial region of the card 200.

The connector 100 includes a casing 10 and multiple contact pins 40. As shown in FIG. 1, the casing 10 includes a slide cover 12, a base cover 13, and a housing 11. An openable and closable shell is configured in the casing 10 by one end of the slide cover 12 being rotatably and slidably linked to one end of the base cover 13.

The base cover 13 includes a bottom plate 13a and a side plate 13b. The bottom plate 13a is included in the bottom surface of the connector 100. The side plate 13b is formed to be bent from the edge of the bottom plate 13a. As shown in FIG. 1, bearings 13c are located respectively in a pair of side plates 13b at one longitudinal-direction end. The bearings 13c are notches that extend in the longitudinal direction in the side plate 13b.

The slide cover 12 includes a planar plate 12a and a side plate 12b. The planar plate 12a is included in the upper surface of the connector 100. The side plate 12b is formed to be bent from the edge of the planar plate 12a. As shown in FIG. 1, guide portions 12ba are located respectively at a pair of side plates 12b. Also, shafts 12c are located respectively in the pair of side plates 12b at one longitudinal-direction end. For example, the shafts 12c are projections that protrude outward.

The pair of shafts 12c are inserted from the inner sides of the pair of bearings 13c of the base cover 13. The shafts 12c are rotatably and slidably formed in the bearings 13c. The slide cover 12 is rotatably and slidably linked to the base cover 13 by the shafts 12c and the bearings 13c. The slide cover 12 and the base cover 13 include, for example, conductive metal plates or insulating resins.

The housing 11 is located inside the base cover 13. The housing 11 holds the multiple contact pins 40 and insulates the multiple contact pins 40 from each other. The housing 11 includes, for example, an insulating resin.

As shown in FIG. 4, the connector 100 includes a space 50 that is surrounded with the slide cover 12, the base cover 13, and the housing 11 in the state in which the slide cover 12 is closed. The space 50 includes a storage portion 51 that houses the card 200, and a deformation-permitting portion 52 that permits elastic deformation of the contact pin 40. The storage portion 51 is a space between the planar plate 12a of the slide cover 12 and the housing 11 or the contact pin 40. Thus, the casing 10 includes the storage portion 51.

As shown in FIG. 1, the multiple contact pins 40 are arranged in one column and are held by the housing 11. As shown in FIG. 1, the arrangement direction of the contact pins 40 is taken as a “direction X”; the direction in which the contact pins 40 extend orthogonal to the direction X is taken as a “direction Y”; and the thickness direction of the connector 100 that is orthogonal to the directions X and Y is taken as a “direction Z”. For convenience of description hereinbelow, the length in the direction X is also called the “width”; the length in the direction Z is also called the “height”; the negative-direction side of the direction Y is also called the “tip side of the contact pin (or the elastic contact part)”; the positive direction of the direction Z is also called “upward”; and the negative direction of the direction Z is also called “downward”.

As shown in FIG. 1 and FIGS. 3A and 3B, the contact pin 40 includes an elastic contact part 41, a holding part 42, and a connection part 43. The holding part 42 is located between the elastic contact part 41 and the connection part 43. For example, the elastic contact part 41, the holding part 42, and the connection part 43 are formed from the same material to have a continuous body. The contact pin 40 is formed by bending a metal plate that has a plate thickness of, for example, 0.2 mm to 0.5 mm and includes, for example, copper (Cu), tin (Sn), and phosphorus (P). The contact pin 40 has a substantially slender strip shape that is bent.

The elastic contact part 41 is the portion at the tip side of the contact pin 40 and accounts for, for example, not less than half of the contact pin 40 in the direction Y. The elastic contact part 41 is bent multiple times in the longitudinal direction and undulates in the direction Z at multiple locations. For example, the elastic contact part 41 is wider than the holding part 42 and the connection part 43 and is positioned higher than the holding part 42 and the connection part 43.

The holding part 42 is linked to the end portion of the elastic contact part 41 that is inclined downward. The holding part 42 has a flat shape.

The connection part 43 is formed by bending the end portion of the holding part 42 exposed from under the housing 11 downward and has a flat shape. The connection part 43 is the portion at the base side of the contact pin 40. For example, the length in the direction Y of the connection part 43 is less than the length in the direction Y of the holding part 42. For example, the width of the connection part 43 is substantially equal to the width of the holding part 42.

As shown in FIG. 3C, the entire contact pin 40 is covered with a first plating layer M1. As shown in FIGS. 3A to 3C, a second plating layer M2 is formed on the first plating layer M1 from a plating boundary line M3 set on the elastic contact part 41 toward the connection part 43 side. Thereby, the second plating layer M2 of the contact pin 40 is exposed at the portion of the elastic contact part 41 at the holding part 42 side, at the entire holding part 42, and at the entire connection part 43. On the other hand, the first plating layer M1 is exposed at the portion of the elastic contact part 41 at the tip side with respect to the plating boundary line M3. The first plating layer M1 is formed of a metal that includes nickel (Ni). The second plating layer M2 is formed of a metal that includes gold (Au) or tin (Sn).

The shape of the elastic contact part 41 will now be described more specifically.

For example, the elastic contact part 41 is caused to contact the electrode 200P by contact pressure generated by the elastic contact part 41 deflecting by abutting the electrode 200P of the card 200. As shown in FIG. 3A, the elastic contact part 41 includes a first protrusion P1 and a second protrusion P2. A recess R is between the first protrusion P1 and the second protrusion P2.

As shown in FIG. 4, the first protrusion P1 protrudes toward the storage portion 51. For example, the first protrusion P1 protrudes toward the direction Z. The first protrusion P1 includes a contact surface P11. The contact surface P11 faces the storage portion 51. The contact surface P11 is substantially parallel to the electrode 200P of the card 200 when the card 200 is mounted to the connector 100. Also, the contact surface P11 is substantially parallel to the planar plate 12a of the slide cover 12. The width of the first protrusion P1 is, for example, about 0.5 mm.

As shown in FIG. 4, the second protrusion P2 protrudes in a direction that crosses the direction Y. Specifically, the second protrusion P2 also protrudes toward the storage portion 51. The second protrusion P2 protrudes toward the direction Z. The second protrusion P2 is located at the tip side of the contact pin 40 with respect to the first protrusion P1 (hereinbelow, also called the “opposite direction Y′ side” which is in the opposite direction of the direction Y) and is separated from the first protrusion P1. The second protrusion P2 faces a direction that crosses the storage portion 51.

As shown in FIGS. 3A and 3B, the second protrusion P2 includes a first surface P21, a second surface P22, and a first ridge P2r.

The first surface P21 is a flat surface facing the storage portion 51 and is, for example, rectangular. As shown in FIG. 4, the first surface P21 is substantially parallel to the surface of the electrode 200P of the mounted card 200.

The second surface P22 contacts the first surface P21 at the opposite direction Y′ side of the first surface P21. The second surface P22 is, for example, a substantially flat surface. The second surface P22 is parallel to the direction X. The second surface P22 is inclined with respect to the first surface P21. It is favorable for the angle between the second surface P22 and the first surface P21 to be not less than 90 degrees, e.g., 135 degrees.

As shown in FIGS. 3A and 3B, the first ridge P2r is a boundary line of the second and first surfaces P22 and P21. As shown in FIGS. 3A and 3B and FIG. 4, the first ridge P2r crosses the direction Y when viewed from the storage portion 51 side. Specifically, the first ridge P2r is substantially orthogonal to the direction Y when viewed from the storage portion 51 side and extends substantially in the direction X.

As shown in FIG. 3A, a height HP2 of the second protrusion P2 is the distance between the first surface P21 of the second protrusion P2 and the bottom surface of the recess R and is, for example, about 0.1 mm to 1 mm. For example, the height HP2 of the second protrusion P2 is substantially equal to the height of the first protrusion P1, i.e., the distance between the contact surface P11 of the first protrusion P1 and the bottom surface of the recess R.

The width of the second protrusion P2 is greater than the width of the first protrusion P1. The width of the second protrusion P2 is, for example, 0.7 mm to 1 mm. As shown in FIG. 4, a length LP between edges of the first and second protrusions P1 and P2 in the direction Y is, for example, 1.2 mm to 3.0 mm.

The recess R is open toward the storage portion 51 and includes a first inner surface R1, a second inner surface R2, and a third inner surface R3. The first inner surface R1 is an inclined surface of the first protrusion P1; the second inner surface R2 also is an inclined surface of the second protrusion P2. The third inner surface R3 is the bottom surface of the recess R and is located between the first inner surface R1 and the second inner surface R2.

As shown in FIGS. 3A and 3B, the width of the second inner surface R2 and the width of the third inner surface R3 are, for example, substantially equal to the width of the first surface P21 of the second protrusion P2. For example, the width of the first inner surface R1 decreases toward the contact surface P11 of the first protrusion P1 and is substantially equal to the width of the contact surface P11 at the portion that contacts the contact surface P11.

As shown in FIG. 4, the first inner surface R1 contacts the contact surface P11 of the first protrusion P1 via a contact surface-side ridge P1r. The contact surface-side ridge P1r crosses the direction Y when viewed from the storage portion 51 side. Specifically, the contact surface-side ridge P1r is substantially orthogonal to the direction Y when viewed from the storage portion 51 side and is substantially parallel to the first ridge P2r.

The plating of the first protrusion P1, the second protrusion P2, and the recess R will now be described further.

As shown in FIGS. 3A to 3C, the second plating layer M2 is formed on the first plating layer M1 at the first protrusion P1. Therefore, the second plating layer M2 is exposed at the first protrusion P1. Specifically, the plating boundary line M3 is set to a position of the first inner surface R1 of the recess R next to the contact surface-side ridge P1r. Thereby, the second plating layer M2 is exposed at the contact surface-side ridge P1r and the first protrusion P1. The first plating layer M1 also is exposed at the recess R and the second protrusion P2 other than the contact surface-side ridge P1r vicinity. As described above, the first plating layer M1 includes nickel; and the second plating layer M2 includes gold or tin. Therefore, the first plating layer M1 is harder due to material characteristics than the second plating layer M2. Accordingly, the surface of the second protrusion P2 is harder than the surface of the first protrusion P1.

According to the embodiment, the second plating layer M2 is formed on the portion of the contact pin 40 at the connection part 43 side with respect to the plating boundary line M3, but the second plating layer M2 is not limited thereto. Specifically, for example, the second plating layer M2 may be formed on the contact pin 40 at the portion that includes the contact surface P11 and at the entire connection part 43. Because the solderability of the connection part 43 is good when an additive such as flux or the like is used on the first plating layer M1, for example, the second plating layer M2 may be formed on the contact pin 40 only at the portion that includes the contact surface P11.

An operation of the connector 100 according to the embodiment will now be described.

First, as shown in FIG. 1, one end of the slide cover 12 of the connector 100 is set to the open state by rotating the one end toward the direction Z. In this state, the card 200 is inserted tip-first along the guide portions 12ba of the pair of side plates 12b of the slide cover 12.

As shown in FIG. 2, the slide cover 12 is returned to the original position by rotating; and the slide cover 12 is temporarily mated with the base cover 13. In the temporarily-mated state, the card 200 is in a mounting standby state. The mounting standby state is a state in which the shafts 12c of the slide cover 12 can slide in the direction Y through the bearings 13c of the base cover 13, and is a state in which the card 200 can have sliding contact with and be connected to the elastic contact part 41 of the contact pin 40 as shown in FIG. 4.

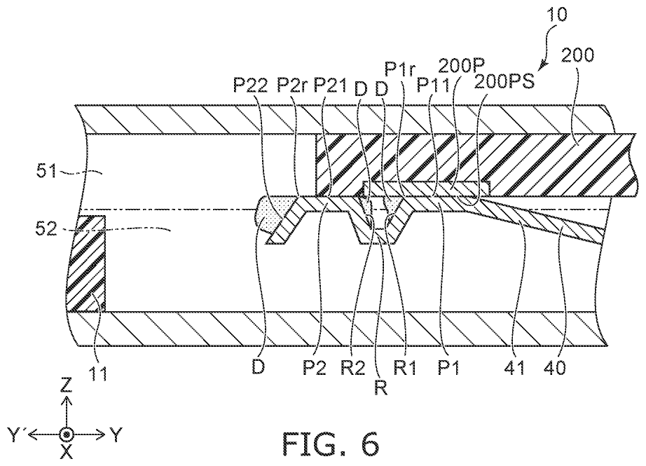

In the mounting standby state as shown in FIG. 5, the slide cover 12 is displaced toward the direction Y and is moved toward the mounted state of the card 200. The mounted state is a state in which the card 200 is connected to the contact pin 40 as shown in FIG. 6, and specifically, a state in which the electrode 200P contacts the first protrusion P1. As shown in FIG. 4, a slide length LS of the slide cover 12 in the mounting process of the card 200 from the mounting standby state to the mounted state is, for example, about 2 mm; and the movement amount of the card 200 in the mounting process is substantially equal to the slide length LS. The slide length LS is greater than the length LP between the edges of the first and second protrusions P1 and P2.

The second protrusion P2 is located at the opposite direction Y′ side that is opposite the direction Y side with respect to the first protrusion P1; and due to the separation from the first protrusion P1, the second protrusion P2 contacts the electrode 200P of the card 200 before the first protrusion P1 when the card 200 is moved through the storage portion 51 along the direction Y.

Because the card 200 is directly handled by the hand of an operator, dirt from hands and fingers such as sweat, an oil film, or the like, foreign matter such as dust from the outside, a fiber, a solid substance, etc., are adhered or stuck to a surface 200PS of the electrode 200P of the card 200. As shown in FIG. 4, foreign matter D is stuck to the electrode surface 200PS. In the mounting process as shown in FIG. 5, when the card 200 is inserted with a card insertion force FI in the direction Y, first, the second protrusion P2 has relative sliding contact with the electrode 200P. At this time, the second surface P22 and the first ridge P2r press on the foreign matter D with a pressure FP toward the opposite direction Y′. The pressure FP is, for example, less than the value of the card insertion force FI divided by the number of contact pins 40. As shown in FIG. 5, at least a portion of the foreign matter D is deformed and displaced thereby. At this time, the elastic contact part 41 does not buckle easily because the angle between the first surface P21 and the second surface P22 of the second protrusion P2 is not less than 90 degrees.

Even when the foreign matter D is stuck to the electrode surface 200PS, the foreign matter D does not remain easily because the region of the second surface P22 at the first ridge P2r vicinity applies a load toward the opposite direction Y′ at the portion of the foreign matter D at the vicinity of the electrode surface 200PS.

Then, the first surface P21 relatively slides while being pressed onto the electrode surface 200PS with a contact pressure FC. Thereby, for example, the first surface P21 can detach the foreign matter D that remains adhered to the electrode surface 200PS.

The second protrusion P2 effectively removes the foreign matter because the first surface P21 that is a flat surface has sliding contact with the electrode surface 200PS. Also, the second protrusion P2 can perform stable foreign matter removal even when wear occurs due to repeated attaching and detaching of the card 200 because the height of the first surface P21 does not change easily and has sliding contact with the electrode surface 200PS over a surface.

As shown in FIG. 6, for example, the foreign matter D that is displaced by the second surface P22 and by the first ridge P2r of the second protrusion P2 is deposited on the second surface P22 at the vicinity of the first ridge P2r. Of the foreign matter D that is detached by the sliding contact of the first surface P21, for example, a portion is deposited on the first and second inner surfaces R1 and R2 of the recess R by being displaced in the direction Y while rubbing between the first surface P21 and the electrode surface 200PS; a portion is clamped between the card 200 and the first surface P21; and a portion remains on the electrode surface 200PS. The foreign matter D that remains on the electrode surface 200PS is scraped off by the contact surface-side ridge P1r and the first inner surface R1 at the contact surface-side ridge P1r vicinity by further movement of the card 200 in the direction Y, and is deposited on the first inner surface R1 of the recess R.

Thus, at least a portion of the foreign matter D at the sliding contact region of the electrode surface 200PS of the card 200 that has sliding contact with the second protrusion P2 is removed. In the sliding contact region, the region that has sliding contact with the contact surface-side ridge P1r is a finished sliding contact region that more reliably removes the foreign matter. The width of the sliding contact region is substantially equal to the width of the second protrusion P2; and the width of the finished sliding contact region is substantially equal to the width of the first protrusion P1. The finished sliding contact region is a region other than at least a portion of the sliding contact region at the direction Y side.

When viewed from the card 200, the first protrusion P1 contacts the finished sliding contact region of the electrode 200P of the card 200 by passing through substantially the same trajectory as the second protrusion P2. For example, the contact surface P11 of the first protrusion P1 has surface contact with the electrode surface 200PS. Therefore, the contact property between the first protrusion P1 and the electrode 200P directly after mounting the card 200 is good. Also, the long-term contact stability is good because the foreign matter is deposited on the second surface P22 and the recess R and is separated from the contact surface P11. Specifically, the contact state that has long-term stability is easily maintained because the foreign matter is separated from the contact surface P11 even when the electrode 200P is displaced due to thermal expansion of the synthetic resin of the card 200, etc.

The width of the second protrusion P2 is greater than the width of the first protrusion P1 so that the foreign matter removal area of the electrode surface 200PS is wide. Thereby, the foreign matter D that is removed is separated from the first protrusion P1 not only in the opposite direction Y′ at which the second protrusion P2 is located but also in the width direction. Specifically, for example, in the mounted state of the card 200, the foreign matter D that is most proximate to the first protrusion P1 in the width direction is separated from the first protrusion P1 by at least the distance of substantially half of the width difference between the second protrusion P2 and the first protrusion P1.

Effects of the embodiment will now be described.

According to the embodiment, the elastic contact part 41 includes the first protrusion P1 that includes the contact surface P11, and the second protrusion P2 that is separated from the first protrusion P1 in the opposite direction Y′ side that is opposite to the direction Y in which the card 200 is mounted. Thereby, the contact stability between the first protrusion P1 and the electrode 200P is high because the second protrusion P2 has sliding contact with the electrode surface 200PS of the card 200 before the first protrusion P1, and because the first protrusion P1 contacts the sliding contact region at which at least a portion of the foreign matter D is removed.

The second protrusion P2 can effectively remove the foreign matter of the electrode surface 200PS because the first surface P21 is a flat surface. Thereby, for example, in the connector 100 according to the embodiment in which the slide cover 12 is rotated onto the base cover 13 to temporarily mate with the base cover 13, and in which the card 200 is subsequently mounted by sliding the slide cover 12, the foreign matter can be effectively removed even if the movement amount due to the sliding is set to be small.

The second protrusion P2 includes the first surface P21 that is substantially parallel to the electrode 200P, and the second surface P22 that is located at the opposite direction Y′ side of the first surface P21. Thereby, the second surface P22 presses the foreign matter D toward the opposite direction Y′ side and displaces the foreign matter D; and the foreign matter D is deposited on the second surface P22. Also, the first surface P21 displaces the foreign matter D by having sliding contact with the electrode surface 200PS while applying contact pressure to the electrode surface 200PS; and a portion of the foreign matter D is deposited in the recess R. Thereby, the first protrusion P1 is separated from the displaced foreign matter D by the second surface P22 and the recess R. Thus, even if the contact location between the first protrusion P1 and the electrode 200P is displaced by a vibration or a temperature change in the mounted state, the foreign matter D can be prevented from being interposed between the first protrusion P1 and the electrode 200P.

The second protrusion P2 includes a first ridge P2r between the first surface P21 and the second surface P22; and the first ridge P2r applies a load to the portion of the foreign matter D at the vicinity of the electrode surface 200PS; therefore, the foreign matter D that is adhered to the electrode surface 200PS is easily detached. The second protrusion P2 is harder due to material characteristics because the first plating layer M1 that includes nickel is exposed; therefore, the second protrusion P2 easily detaches the foreign matter D, is resistant to wear, and has good corrosion resistance. The second plating layer M2 that includes, for example, gold is formed on the first plating layer M1 and left exposed at a portion of the first protrusion P1 that includes at least the contact surface P11. The second plating layer M2 that includes gold that has better conductivity and is softer than nickel reduces the contact resistance between the electrode surface 200PS and the contact surface P11 and improves the contact stability of the contact pin 40.

Because the angle between the first surface P21 and the second surface P22 is set to be not less than 90 degrees, buckling of the elastic contact part 41 can be suppressed. Because the second protrusion P2 is wider than the first protrusion P1, the first protrusion P1 contacts a wide foreign matter removal area of the electrode surface 200PS. Because the foreign matter removal area is wide, for example, the first protrusion P1 can be separated from the foreign matter D that has shifted to the side of the foreign matter removal area in the mounted state. Thus, the contact stability of the contact pin 40 can be improved.

The contact surface-side ridge P1r between the recess R and the first protrusion P1 can scrape off even the slight foreign matter D that remains at the electrode surface 200PS in the mounting process and can deposit the foreign matter D in the recess R. Accordingly, the contact stability can be further improved because the contact surface P11 of the first protrusion P1 contacts the finished sliding contact region that had sliding contact with the contact surface-side ridge P1r.

As described above, according to the contact pin 40 according to the embodiment, the foreign matter D that is micro and difficult to visually confirm can be effectively separated from the first protrusion P1 by the second protrusion P2 and the recess R; and the contact stability can be improved.

The contact surface P11 of the first protrusion P1 is substantially parallel to the electrode surface 200PS; therefore, the contact area with the electrode surface 200PS is large; and the contact resistance is small.

Although the first ridge P2r is a ridge between the first surface P21 and the second surface P22 according to the embodiment, the first ridge P2r may be a bent surface. Although the contact surface P11 of the first protrusion P1 and the first surface P21 of the second protrusion P2 both are planar according to the embodiment, the contact surface P11 and the first surface P21 are not limited thereto; for example, at least one of the contact surface P11 or the first surface P21 may be planar. Although the first protrusion P1 includes the contact surface P11 that is planar, for example, a curved contact surface or a projecting contact surface may be included.

Although the tip of the elastic contact part 41 is a free end according to the embodiment, the elastic contact part 41 is not limited to a cantilever spring type. For example, the elastic contact part 41 may be a doubly-supported spring type in which the tip also is supported by a housing, etc.

Although the connector 100 according to the embodiment is electrically connected with, for example, a card-type storage medium, i.e., a micro SD, the connector 100 is not limited thereto. For example, the connector may connect another card-type storage medium such as a SIM card, an SD card, a B-CAS card, etc.

Although eight contact pins 40 are arranged in the connector 100 according to the embodiment, for example, 13×3 contact pins may be arranged. In such a case, for example, the connector may electrically connect a card-type SSD (solid-state drive). In such a case, the electrodes of the SSD are easily contaminated because the electrode occupancy ratio is high. SSDs are being utilized also as infrastructure control devices to replace PC memory; therefore, by using the contact pin 40 according to the embodiment, the connection stability can be improved over a long period of time; and operations that use the SSD can be stabilized. The contact pin 40 according to the embodiment also can be used in a connector in which the card is directly inserted into the storage portion 51 that is exposed externally without using the slide cover for the mounting. The connection body of the connector according to the embodiment may not be a card-type storage medium; for example, the connection body may be another connector such as a USB connector, etc.

### Second Embodiment

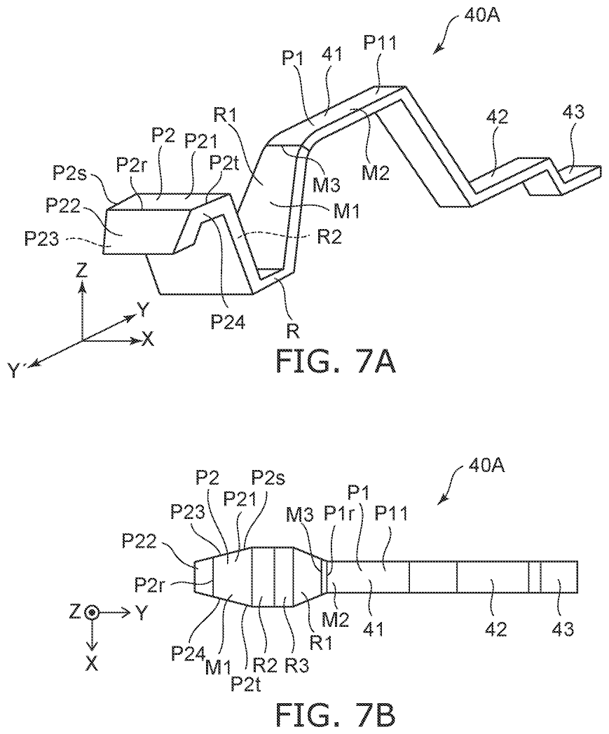

FIG. 7A is a perspective view showing a contact pin according to the embodiment; and FIG. 7B is a plan view of the contact pin.

The first surface P21 of the second protrusion P2 of the contact pin 40A according to the embodiment is substantially trapezoidal; the contact pin 40A further includes a third surface P23 and a fourth surface P24 that contact the first surface P21 at the opposite direction Y′ side of the first surface P21.

As shown in FIGS. 7A and 7B, the first surface P21 of the contact pin 40A according to the embodiment is substantially trapezoidal and is substantially parallel to the electrode of the card. When the first surface P21 corresponds to a trapezoid, the first ridge P2r corresponds to the upper base; and a second ridge P2s and a third ridge P2t correspond to two legs. The second ridge P2s and the third ridge P2t contact the two ends of the first ridge P2r.

The third surface P23 contacts the second surface P22 and contacts the first surface P21 via the second ridge P2s. The angle between the third surface P23 and the first surface P21 is, for example, a right angle. The fourth surface P24 contacts the second surface P22 and contacts the first surface P21 via the third ridge P2t. The angle between the fourth surface P24 and the first surface P21 is, for example, a right angle.

As shown in FIG. 7B, for example, the first ridge P2r is substantially orthogonal to the direction Y. The second ridge P2s and the third ridge P2t are lines that are inclined with respect to the direction Y. Accordingly, in the mounting process of the card, the foreign matter that is pressed by the third surface P23 that includes the second ridge P2s also is displaced in the opposite direction of the direction X while being pushed in the opposite direction Y′. In other words, in the mounting process of the card, the foreign matter is easily ejected from the path of the second protrusion P2 because the foreign matter that is pressed by the third surface P23 that includes the second ridge P2s is displaced along the third surface P23 in a direction parallel to the second ridge P2s that has an acute angle with the direction Y.

Similarly, in the mounting process of the card, the foreign matter that is pressed by the fourth surface P24 that includes the third ridge P2t is also displaced in the direction X by the fourth surface P24 while being pushed in the opposite direction Y′. In other words, in the mounting process of the card, the foreign matter is easily ejected from the path of the second protrusion P2 because the foreign matter that is pressed by the fourth surface P24 that includes the third ridge P2t is displaced along the fourth surface P24 in a direction parallel to the third ridge P2t that has an acute angle with the direction Y.

As shown in FIGS. 7A and 7B, a curved surface that is not a ridge is formed between the first protrusion P1 and the recess R. In the mounting process of the card, the wear of the edge of the first protrusion P1 at the direction Y side can be prevented thereby; the foreign matter that remains at the electrode surface is scraped off and deposited on the first inner surface R1 of the recess R; and the first protrusion P1 contacts in the finished sliding contact region.

According to the embodiment as described above, compared to the contact pin 40A according to the first embodiment, much of the removed foreign matter can be deposited at two sides of the foreign matter removal region in the direction X.

Otherwise, the configuration, the operations, and the effects of the embodiment are similar to those of the first embodiment.

### Third Embodiment

The first surface P21 of the second protrusion P2 of a contact pin 40B according to the embodiment is, for example, a curved surface made by stamping.

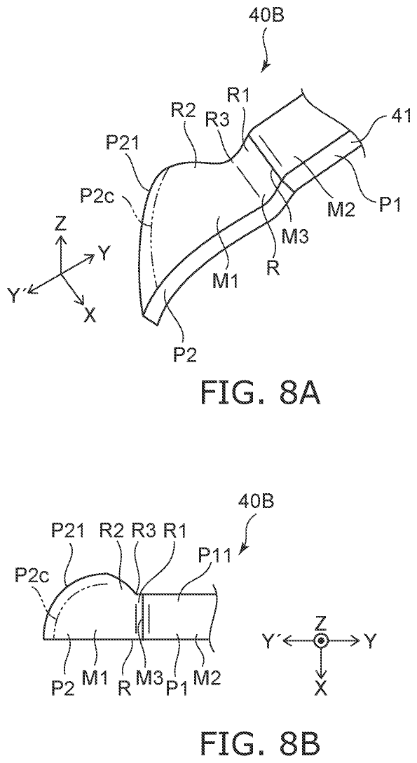

FIG. 8A is an enlarged perspective view showing the tip of the contact pin according to the embodiment; and FIG. 8B is a plan view of the tip of the contact pin.

As shown in FIGS. 8A and 8B, the first surface P21 of the second protrusion P2 is a curved surface that protrudes toward the storage portion 51. The first surface P21 is, for example, a curved surface that protrudes along a first line P2c. For example, the position in the direction Z of the first line P2c is substantially the same in the first surface P21. For example, the first line P2c is a curve that crosses the direction Y when viewed from above. Specifically, as shown in FIG. 8B, when viewed from above, the first line P2c is an arc-like curve that extends over the width of the second protrusion P2 and is continuous from one end of the second protrusion P2 positioned at the opposite direction Y′ side and the direction X side to another end of the second protrusion P2 positioned at the direction Y side and the opposite-direction side in the direction X. The direction in which the first line P2c extends is nearly the direction X at the one end at the direction X side and continuously changes along the negative direction of the direction X to be nearly the direction Y.

As shown in FIGS. 8A and 8B, the first surface P21 of the second protrusion P2 is a curved surface that is continuous with the second inner surface R2 of the recess R. The first surface P21 that is a curved surface that protrudes upward is continuous with the curved surfaces of the first and second inner surfaces R1 and R2 that protrude downward.

Similarly to the first embodiment, the first protrusion P1 includes the contact surface P11. The first inner surface R1 contacts the contact surface P11 of the first protrusion P1 via a curved surface instead of a ridge.

In the mounting process of the card, the portion of the first surface P21 of the second protrusion P2 on the first line P2c has sliding contact on the electrode of the card. At this time, for example, the foreign matter that is pressed by the portion of the first surface P21 at the opposite direction Y′ side of the first line P2c is displaced also in the opposite direction of the direction X while being pushed in the opposite direction Y′. In other words, in the mounting process of the card, the foreign matter that is pressed by the portion of the first surface P21 at the opposite direction Y′ side of the first line P2c is displaced along the first surface P21 in a direction parallel to the first line P2c that has an acute angle with the direction Y, and is easily ejected toward the side opposite to the direction X side of the path of the second protrusion P2.

For example, the foreign matter that is detached by the sliding contact of the portion of the first line P2c of the first surface P21 while the contact pressure is applied to the electrode surface crosses over the first line P2c and is deposited on the first inner surface R1 or the second inner surface R2 of the recess R.

Because the first surface P21 of the second protrusion P2 is a curved surface, buckling of the elastic contact part 41 in the mounting process of the card is suppressed.

As described above, according to the contact pin 40B according to the embodiment, compared to the contact pin 40 according to the first embodiment, much of the removed foreign matter can be deposited at one side of the foreign matter removal region.

Otherwise, the configuration, the operations, and the effects of the embodiment are similar to those of the first embodiment.

### Fourth Embodiment

In a contact pin 40C according to the embodiment, the second protrusion P2 is, for example, semicylindrical; and the contact pin 40C includes a third protrusion P3.

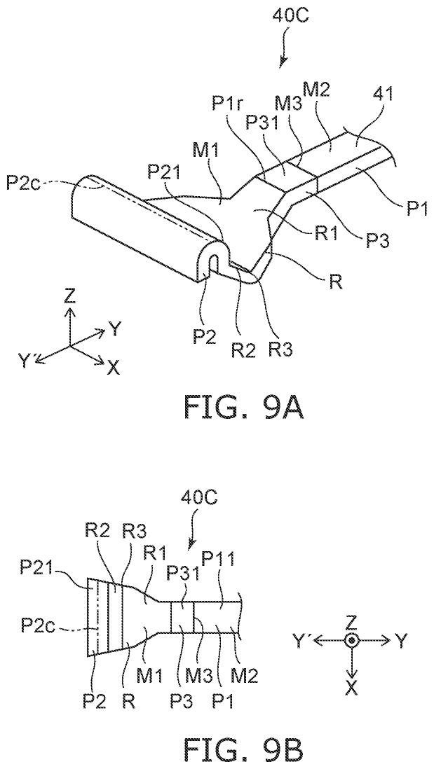

FIG. 9A is an enlarged perspective view showing the tip of the contact pin according to the embodiment; and FIG. 9B is a plan view of the tip of the contact pin.

As shown in FIGS. 9A and 9B, the first surface P21 of the second protrusion P2 is a curved surface protruding toward the storage portion 51. The first surface P21 is, for example, a curved surface protruding along the first line P2c. In the first surface P21, for example, the position in the direction Z of the first line P2c is substantially the same. For example, the first line P2c is a straight line that is substantially orthogonal to the direction Y when viewed from above. The cross-sectional shape of the second protrusion P2 perpendicular to the first line P2c is substantially the same along the direction X. The cross-sectional shape of the first surface P21 of the second protrusion P2 perpendicular to the first line P2c is an inverted U-shape and is substantially the same along the direction X.

Similarly to the first embodiment, the first protrusion P1 includes the contact surface P11. The third protrusion P3 is formed between the first protrusion P1 and the recess R. The third protrusion P3 includes a first surface P31 that has sliding contact with the electrode of the card in the mounting process of the card. The first surface P31 is substantially parallel to the contact surface P11 of the first protrusion P1 and contacts the contact surface P11. The first surface P31 of the third protrusion P3 and the first inner surface R1 of the recess R contact each other via the contact surface-side ridge P1r. Other than the existence or absence of the second plating layer M2 described below, the upper surface of the third protrusion P3 and the upper surface of the first protrusion P1 are formed of a substantially continuous flat surface.

For the plating layers as shown in FIGS. 9A and 9B, the plating boundary line M3 is set between the first protrusion P1 and the third protrusion P3; and the second plating layer M2 is formed on the first plating layer M1 of the contact pin 40C at the direction Y side of the plating boundary line M3. Thereby, the second plating layer M2 is not formed on the third protrusion P3. The first plating layer M1 is exposed at the third protrusion P3, the recess R, and the contact surface-side ridge P1r. The third protrusion P3, the recess R, and the contact surface-side ridge P1r are harder than the first protrusion P1.

The second inner surface R2 of the recess R contacts the first surface P21 of the second protrusion P2. The second inner surface R2 is positioned at the lower side (the negative-direction side in the direction Z) of the first surface P21 of the second protrusion P2. The width of the second inner surface R2 gradually decreases toward the third inner surface R3 from the width at the first surface P21 side of the second protrusion P2. The width of the first inner surface R1 decreases in stages from the third inner surface R3 toward the contact surface-side ridge P1r to become substantially equal to the width of the third protrusion P3. The width of the third protrusion P3 is substantially equal to the width of the first protrusion P1.

In the mounting process of the card, the portion of the first surface P21 of the second protrusion P2 on the first line P2c has sliding contact on the electrode surface of the card. At this time, for example, the foreign matter that is not stuck to the electrode surface is displaced by the opposite direction Y′ side of the first line P2c of the first surface P21 toward the opposite direction Y′ side. For example, the foreign matter that is stuck to the electrode surface is detached by the sliding contact due to the portion of the first line P2c of the first surface P21, crosses over the first line P2c, and is deposited on the first inner surface R1 or the second inner surface R2 of the recess R.

In the mounting process of the card, the electrode surface is further cleaned because the first surface P31 of the third protrusion P3 similarly has sliding contact with the electrode surface.

Corrosion and wear of the contact surface-side ridge P1r can be suppressed because the first plating layer M1 is exposed at the contact surface-side ridge P1r.

Buckling of the elastic contact part 41 is suppressed because the first surface P21 of the second protrusion P2 is a curved surface.

As described above, according to the embodiment as well, the contact stability can be improved.

Otherwise, the configuration, the operations, and the effects of the embodiment are similar to those of the first embodiment.

### Fifth Embodiment

In a contact pin 40D according to the embodiment, the second protrusion P2 is spear-shaped; and the first protrusion P1 is a projection formed in the surface of the elastic contact part 41. The recess R is not formed.

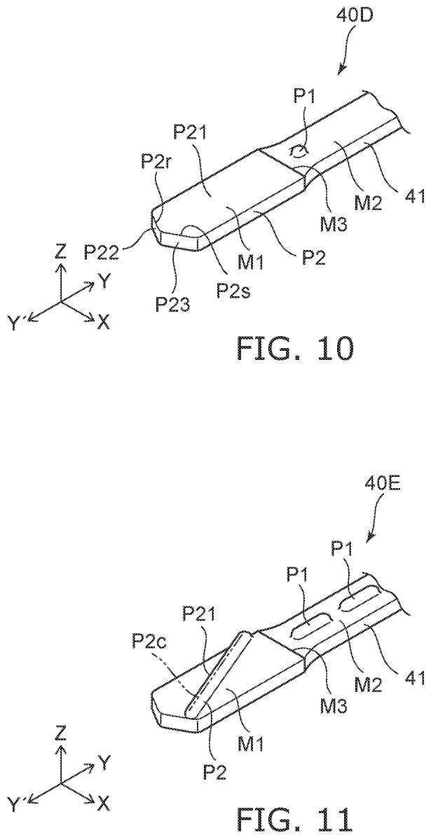

FIG. 10 is an enlarged perspective view showing the tip of the contact pin according to the embodiment.

According to the embodiment as shown in FIG. 10, the second protrusion P2 includes the first surface P21, the second surface P22, and the third surface P23. The first surface P21 is substantially flat. The center of the end portion of the first surface P21 at the opposite direction Y′ side when viewed from the storage portion 51 protrudes toward the opposite direction Y′ side.

The second surface P22 contacts the first surface P21 at the opposite direction Y′ side of the first surface P21. The second surface P22 contacts the first surface P21 via the first ridge P2r. The angle between the second surface P22 and the first surface P21 is, for example, a right angle.

The third surface P23 contacts the first surface P21 at the opposite direction Y′ side of the first surface P21. The third surface P23 contacts the first surface P21 via the second ridge P2s. The angle between the third surface P23 and the first surface P21 is, for example, a right angle.

According to the embodiment as shown in FIG. 10, the first ridge P2r and the second ridge P2s are lines that are inclined with respect to the direction Y. The first ridge P2r and the second ridge P2s extend in directions away from each other along the direction Y.

The foreign matter that is pressed by the second surface P22 is displaced also in the opposite direction of the direction X while being pressed in the opposite direction Y′. In other words, in the mounting process of the card, the foreign matter that is pressed by the second surface P22 is easily ejected from the path of the second protrusion P2 because the foreign matter is displaced along the second surface P22 in a direction parallel to the first ridge P2r that has an acute angle with the direction Y.

Similarly, in the mounting process of the card, the foreign matter that is pressed by the third surface P23 that includes the second ridge P2s is displaced also in the direction X while being pushed in the opposite direction Y′ by the third surface P23. In other words, in the mounting process of the card, the foreign matter that is pressed by the third surface P23 is easily ejected from the path of the second protrusion P2 because the foreign matter is displaced along the third surface P23 in a direction parallel to the second ridge P2s that has an acute angle with the direction Y.

Similarly to the first embodiment, for example, in the mounting process of the card, the first surface P21 has sliding contact while applying a contact pressure to the electrode.

The first protrusion P1 is a projection located at the opposite direction Y′ side of the second protrusion P2 on the elastic contact part 41. The first protrusion P1 is located at substantially the center of the width of the surface of the elastic contact part 41 facing the storage portion. The first protrusion P1 protrudes in the direction Z with respect to the periphery. The first protrusion P1 is, for example, substantially hemispherical. The width of the first protrusion P1 is less than the width of the second protrusion P2 and less than the width of the elastic contact part 41. The first protrusion P1 has a point contact with the electrode inside the sliding contact region in the mounted state.

The height of the second protrusion P2 is substantially equal to the plate thickness of the elastic contact part 41.

The height of the first protrusion P1 is greater than the height of the second protrusion P2 by the amount that the projection is formed.

The plate width of the portion of the elastic contact part 41 where the first protrusion P1 is located is less than the plate width of the portion of the elastic contact part 41 where the second protrusion P2 is located.

As described above, according to the contact pin 40D according to the embodiment, compared to the contact pin 40 according to the first embodiment, much of the removed foreign matter can be deposited at the two sides of the foreign matter removal region.

According to the contact pin 40D, the planar tip portion of the elastic contact part 41 is used as the second protrusion P2; and a projection that is formed in the elastic contact part 41 by, for example, stamping is used as the first protrusion P1; therefore, the contact stability can be improved while suppressing the thickness of the tip side of the elastic contact part.

Otherwise, the configuration, the operations, and the effects of the embodiment are similar to those of the first embodiment.

### Sixth Embodiment

In a contact pin 40E according to the embodiment, the first protrusion P1 and the second protrusion P2 are projections that are formed in the elastic contact part 41 by, for example, stamping; and the recess R is not formed.

FIG. 11 is an enlarged perspective view showing the tip of the contact pin according to the embodiment.

According to the embodiment as shown in FIG. 11, the second protrusion P2 is a linear projection located at the tip of the elastic contact part 41. The second protrusion P2 is provided over the width direction of the elastic contact part 41. The second protrusion P2 is formed along the first line P2c. For example, the first line P2c crosses the direction Y when viewed from the storage portion 51 and is a straight line about 30 degrees from the direction Y.

For example, two first protrusions P1 are provided. The first protrusion P1 is located at the opposite direction Y′ side of the second protrusion P2 of the elastic contact part 41. As shown in FIG. 11, the first protrusion P1 is a linear projection along the direction Y. The width of the first protrusion P1 is less than the width of the second protrusion P2.

The plating boundary line M3 is set between the second protrusion P2 and the first protrusion P1 when viewed in plan. The second plating layer M2 is formed in a region that includes the two first protrusions P1 but does not include the second protrusion P2. Thereby, the second plating layer M2 is exposed at the two first protrusions P1. The first plating layer M1 is exposed at the second protrusion P2.

In the mounting process of the card, the second protrusion P2 presses the foreign matter on the electrode surface with, for example, the pressure FP and has sliding contact while applying contact pressure to the electrode surface. Thereby, for example, the foreign matter that is not stuck to the electrode surface is displaced along the second protrusion P2 in a direction (the negative-direction side in the direction X) that has an acute angle with the direction Y and is deposited at the negative-direction side in the direction X of the second protrusion P2. For example, the foreign matter that is stuck to the electrode surface is detached from the electrode surface by the pressure FP, crosses over the first line P2c while moving along the second protrusion P2, and can be deposited at the opposite direction Y′ side of the first line P2c.

The two first protrusions P1 contact the sliding contact region where the foreign matter of the electrode surface is removed. By providing the multiple first protrusions P1, the contact points with the electrode are increased, and contact stability is realized.

The plate width of the portion of the elastic contact part 41 where the first protrusion P1 is located is less than the plate width of the portion of the elastic contact part 41 where the second protrusion P2 is located.

According to the contact pin 40E according to the embodiment, compared to the contact pin 40 according to the first embodiment, much of the removed foreign matter can be deposited at one side of the foreign matter removal region. Similarly to the fifth embodiment, the contact stability can be improved while suppressing the thickness of the tip side of the elastic contact part 41.

Otherwise, the configuration, the operations, and the effects of the embodiment are similar to those of the first embodiment.

### Seventh Embodiment

A contact pin 40F according to the embodiment further includes the third protrusion P3 and a fourth protrusion P4 arranged parallel to the second protrusion P2.

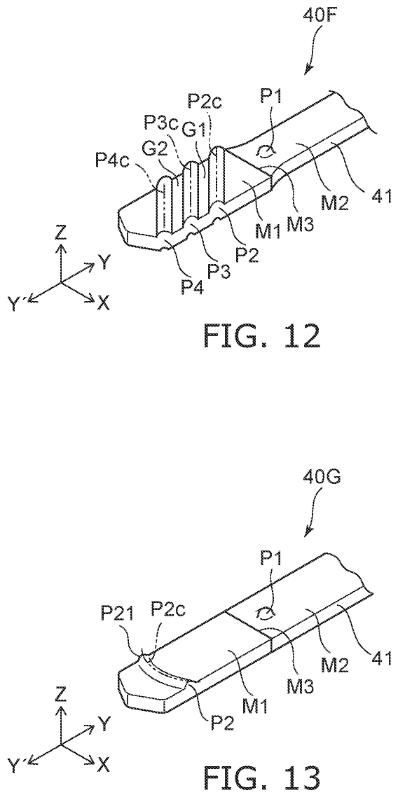

FIG. 12 is an enlarged perspective view showing the tip of the contact pin according to the embodiment.

In the contact pin according to the embodiment, the first to fourth protrusions P1 to P4 are formed by, for example, stamping. As shown in FIG. 12, when viewed from the storage portion 51, the first protrusion P1 is a dot-shaped projection; and the second to fourth protrusions P2 to P4 are linear projections arranged to be parallel. The third protrusion P3 is provided in the elastic contact part 41 at the opposite direction Y′ side of the second protrusion P2; and the fourth protrusion P4 is provided in the elastic contact part 41 at the opposite direction Y′ side of the third protrusion P3.

The second protrusion P2, the third protrusion P3, and the fourth protrusion P4 protrude along the first lines P2c, P3c, and P4c. The first lines P2c, P3c, and P4c are substantially parallel lines crossing the direction Y when viewed from the storage portion 51. The heights of the first lines P2c, P3c, and P4c of the second to fourth protrusions P2 to P4 are substantially the same. The heights of the second to fourth protrusions P2 to P4 are, for example, substantially the same.

The second to fourth protrusions P2 to P4 are provided over the width direction of the elastic contact part 41. The widths of the second to fourth protrusions P2 to P4 are substantially the same. The width of the first protrusion P1 is less than the widths of the second to fourth protrusions P2 to P4.

A first groove G1 is between the second protrusion P2 and the third protrusion P3; and a second groove G2 is between the third protrusion P3 and the fourth protrusion P4.

In the mounting process of the card, the second protrusion P2, the third protrusion P3, and the fourth protrusion P4 urge the foreign matter on the electrode surface toward the opposite direction Y′ and have sliding contact while applying, for example, contact pressure to the electrode surface. Thereby, for example, a portion of the foreign matter that is not stuck is deposited at the opposite direction Y′ side of the fourth protrusion P4; for example, a portion is displaced along the first line P4c in a direction that has an acute angle with the direction Y when viewed from the storage portion 51 and is deposited at one side (the negative-direction side in the direction X) of the fourth protrusion P4. Also, the foreign matter that is stuck is detached by the sliding contact of the second to fourth protrusions P2 to P4; for example, the detached foreign matter crosses over the first lines P2c, P3c, and P4c of the second to fourth protrusions P2 to P4 and is deposited at the direction Y side of the first lines P2c, P3c, and P4c.

In the card-mounted state, the foreign matter that is deposited at the opposite direction Y′ side of the second protrusion P2 and the foreign matter that is deposited at the direction Y side of the third protrusion P3 are stored in the first groove G1 covered with the electrode surface and are separated from the first protrusion P1. The foreign matter that is deposited at the opposite direction Y′ side of the third protrusion P3 and the foreign matter that is deposited at the direction Y side of the fourth protrusion P4 are stored in the second groove G2 covered with the electrode surface and are separated from the first protrusion P1. The foreign matter that is deposited at the opposite direction Y′ side of the fourth protrusion P4 is effectively separated from the first protrusion P1 because the second protrusion P2, the third protrusion P3, and the fourth protrusion P4 are interposed between the foreign matter and the first protrusion P1. Thus, according to the contact pin 40F according to the embodiment, the foreign matter is separated from the first protrusion P1; and the long-term contact stability is good.

According to the contact pin according to the embodiment, by forming the first to fourth protrusions P1 to P4 in the elastic contact part 41 by, for example, stamping, the contact stability can be improved while suppressing the thickness of the tip side of the elastic contact part 41.

Although the first to fourth protrusions P1 to P4 are formed in the elastic contact part 41 by stamping according to the embodiment, the first to fourth protrusions P1 to P4 are not limited thereto; for example, the first to fourth protrusions P1 to P4 may be formed by twisting the tip of the elastic contact part 41 in a spiral shape. Although the second to fourth protrusions P2 to P4 are included in the embodiment, the second protrusion P2 and the third protrusion P3 may be included, or multiple protrusions may be further included.

Otherwise, the configuration, the operations, and the effects of the embodiment are similar to those of the first embodiment.

### Eighth Embodiment

In a contact pin 40G according to the embodiment, the first protrusion P1 and the second protrusion P2 are projections formed in the elastic contact part 41 by, for example, stamping. When viewed in plan, the first protrusion P1 is a dot-shaped projection; the second protrusion P2 is a substantially crescent-shaped projection; and a recess is not formed.

FIG. 13 is an enlarged perspective view showing the tip of the contact pin according to the embodiment.

As shown in FIG. 13, the second protrusion P2 is located at the tip of the elastic contact part 41 and is provided over the width direction of the elastic contact part 41. The second protrusion P2 is formed along the first line P2c. The first line P2c is a curve of which the center protrudes toward the opposite direction Y′ when viewed from the storage portion 51. The cross-sectional shape of the second protrusion P2 perpendicular to the first line P2c is hill-shaped with the first line P2c portion at the apex.

The first protrusion P1 is a dot-shaped projection located at substantially the width-direction center of the elastic contact part 41. The width of the first protrusion P1 is less than the width of the second protrusion P2.

According to the contact pin 40G according to the embodiment, compared to the contact pin 40 according to the first embodiment, much of the removed foreign matter can be deposited at the two sides of the foreign matter removal region.

Also, according to the contact pin 40G, the plate width of the portion of the elastic contact part 41 where the first protrusion P1 is located is substantially equal to the plate width of the portion of the elastic contact part 41 where the second protrusion P2 is located. The contact pressure of the first and second protrusions P1 and P2 is increased thereby, the efficiency of the foreign matter removal is increased, and the contact stability is increased.

Otherwise, the configuration, the operations, and the effects of the embodiment are similar to those of the first embodiment.

According to embodiments of the invention, a connector can be provided in which the contact stability is high.

Hereinabove, exemplary embodiments of the invention are described with reference to specific examples. However, the invention is not limited to these specific examples. For example, various modifications made by one skilled in the art in regard to the configurations, sizes, material qualities, arrangements, etc., of components of connectors such as casings and contact pins are included in the scope of the invention to the extent that the purport of the invention is included. Any two or more components of the specific examples may be combined within the extent of technical feasibility and are included in the scope of the invention to the extent that the purport of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector, comprising:
a casing including a storage portion, a connection body being mounted in the storage portion by being relatively displaced in a first direction; and
a contact pin held by the casing,
the contact pin including an elastic contact part,
the elastic contact part including
a first protrusion protruding toward the storage portion, and
a second protrusion separated from the first protrusion,
the second protrusion facing a direction crossing the storage portion,
the second protrusion protruding in a direction crossing the first direction.

2. The connector according to claim 1, wherein
at least one of the first protrusion or the second protrusion includes a contact surface facing the storage portion, and
the contact surface is planar.

3. The connector according to claim 1, wherein
a surface of the second protrusion is harder than a surface of the first protrusion.

4. The connector according to claim 1, wherein
the contact pin is covered with a first plating layer,
the first plating layer includes nickel,
a second plating layer is located on the first plating layer at the first protrusion,
the second plating layer includes gold or tin,
the second plating layer is exposed at the first protrusion, and
the first plating layer is exposed at the second protrusion.

5. The connector according to claim 1, wherein
a width of the second protrusion is greater than a width of the first protrusion.

6. The connector according to claim 1, wherein
the second protrusion includes:
a first surface facing the storage portion; and
a second surface contacting the first surface at an opposite-direction side of the first surface,
the first surface is planar,
the opposite-direction side is opposite to the first-direction side of the first surface, and
an angle between the first surface and the second surface is obtuse.

7. The connector according to claim 6, wherein
the first surface protrudes toward the opposite-direction side when viewed from the storage portion side, and
the second protrusion further includes a third surface contacting the first surface at the opposite-direction side of the first surface.

8. The connector according to claim 6, wherein
the first surface and the second surface contact via a first ridge, and
the first ridge crosses the first direction when viewed from the storage portion side.

9. The connector according to claim 6, wherein
the first surface is substantially trapezoidal,
the first surface is surrounded with a first ridge, a second ridge, and a third ridge,
the first ridge is positioned between the second surface and the first surface,
the second ridge and the third ridge contact two ends of the first ridge,
the second protrusion further includes a third surface and a fourth surface,
the third surface contacts the first surface via the second ridge and contacts the second surface, and
the fourth surface contacts the first surface via the third ridge and contacts the second surface.

10. The connector according to claim 1, wherein
a first surface of the second protrusion is a curved surface that faces the storage portion and is formed over an overall width of the elastic contact part.

11. The connector according to claim 10, wherein
the first surface protrudes along a first line.

12. The connector according to claim 1, wherein
the second protrusion is formed in a surface of the elastic contact part facing the storage portion, and
the second protrusion is a projection protruding along the first line.

13. The connector according to claim 11, wherein
the first line is substantially linear and crosses the first direction when viewed from the storage portion side.

14. The connector according to claim 11, wherein
the first line extends in a width direction of the second protrusion when viewed from the storage portion side and has an arc-like shape extending from one end at an opposite-direction side to an other end at the first-direction side, and
the opposite-direction side is opposite to the first-direction side.

15. The connector according to claim 11, wherein
the first line protrudes toward an opposite direction of the first direction when viewed from the storage portion side.

16. The connector according to claim 1, wherein
the elastic contact part further includes a third protrusion located at an opposite-direction side of the second protrusion,
the opposite-direction side is opposite to the first-direction side of the second protrusion,
a width of the third protrusion is greater than a width of the first protrusion, and
the second protrusion and the third protrusion extend in a direction crossing the first direction when viewed from the storage portion side and are substantially parallel to each other.

17. The connector according to claim 1, wherein
the first protrusion includes a contact surface facing the storage portion,
the contact surface is planar, and
a recess is between the first protrusion and the second protrusion.

18. The connector according to claim 1, wherein
the first protrusion is located at a central portion of a surface of the elastic contact part facing the storage portion.

19. The connector according to claim 1, wherein
the first protrusion is electrically connected to a metal terminal of the mounted connection body,
the second protrusion has sliding contact with a surface of the metal terminal, and
the first protrusion contacts a region of the surface of the metal terminal to which the second protrusion had sliding contact.

20. A method for connecting a contact pin, the method connecting the contact pin of a connector to an electrode of a connection body by mounting the connection body in the connector by relatively displacing the connection body in a first direction, the method comprising:
causing a second protrusion of the contact pin to have sliding contact with a surface of the electrode; and
causing a first protrusion of the contact pin to contact a region of the surface of the electrode after the second protrusion has slid over the region,
the first protrusion being located at the first-direction side of the second protrusion.

21. A contact pin, comprising:
an elastic contact part including
a first protrusion protruding upward, and
a second protrusion separated from the first protrusion in a longitudinal direction, the second protrusion protruding upward;
a holding part linked to the elastic contact part, the holding part being held by a housing, the housing including an insulating resin; and
a connection part linked to the holding part, the connection part being exposed from under the housing.

22. A storage medium connectable to a connector,
the connector including:
a casing including a storage portion; and
a contact pin including an elastic contact part,
the storage medium being mounted to the storage portion by being relatively displaced in a first direction,
the storage medium comprising:
an electrode surface electrically connected with a first protrusion of the elastic contact part,
the first protrusion protruding toward the storage portion,
a second protrusion of the elastic contact part sliding on the electrode surface,
the second protrusion being separated from the first protrusion and protruding toward a direction crossing the first direction.
